(19) United States
(12) Patent Application Publication
(10) Pub. No.: US 2010/0155320 A1
(43) Pub. Date: Jun. 24, 2010

(54) FEEDWELL DEVICE

(75) Inventor: Tuan Van Nguyen, Victoria (AU)

Correspondence Address: MERCHANT & GOULD PC, P.O. BOX 2903, MINNEAPOLIS, MN, 55402-0903, US

(73) Assignee: COMMONWEALTH SCIENTIFIC AND INDUSTRIAL RESEARCH OR, Campbell (AU)

(21) Appl. No.: 12/600,632

(22) PCT Filed: May 14, 2008
(86) PCT No.: PCT/AU2008/000678

§ 371 Date: Nov. 17, 2009

(30) Foreign Application Priority Data
May 17, 2007 (AU) 2007902630
Nov. 16, 2007 (AU) 2007906295

(51) Int. Cl. B01D 21/24; B01D 21/26; B01D 21/01; G01N 15/02

(52) U.S. Cl. 210/207; 210/519; 210/512.1; 210/205; 73/865.5

(57) ABSTRACT

An apparatus for the flocculation of solid particles in a solid-liquid stream including an enclosure, an upwardly converging flow diverter defining a first zone and a second zone within the enclosure, and a solid-liquid stream inlet into the first zone of the enclosure at or towards the bottom of the first zone in proximity to the lower region of the flow diverter, the upwardly converging flow diverter having an upper opening for fluid communication between the first zone and the second zone. The apparatus is preferably a feedwell for a separation device for separating solid particles from a liquid in a solid-liquid stream.

### FIELD OF THE INVENTION

This invention relates to an apparatus for the flocculation of particles in a solid-liquid stream and in particular to an apparatus and method for use in a solids settling device.

### BACKGROUND OF THE INVENTION

The separation of a suspension of solid particles into supernatant liquid and concentrated sludge is a common industrial process. Depending on the purpose of the separation, the process is termed either thickening (the goal being the concentration of the solid particles) or clarification (the goal being the removal of the solid particles to produce clear liquid). In most instances the driving force for the separation is the size of the solid particles and the difference in density between the solid and the liquid, and therefore these processes are often referred to as sedimentation (or settling) processes. However, these processes are referred to generally as separation devices herein. Thus, the separation is effected by the force of gravity. However, other mechanical separation techniques can be employed such as centrifugal sedimentation or filtration. In some instances a magnetic separation process may be employed. In all cases, the solid settling process proceeds more rapidly for larger-sized particles (for a given density difference). Consequently, in many situations, chemical reagents (known as “coagulants” or “flocculants”) are added to the solid suspension to induce bonding between the solid particles to form “agglomerates” which have a larger overall particle size distribution. This process is known in the art variously as “coagulation”, “flocculation”, “aggregation” or “agglomeration” (but will herein be referred to as flocculation). In some instances, bonding between solid particles to form agglomerates which have a larger overall particle size distribution, may occur naturally without the presence of a chemical reagent.

The most common type of separation device is the cylindrical batch or continuous gravity thickener with mechanical sludge-raking arms. In this type of device, shown in FIG. 1, a solid-liquid stream, that is, a liquid stream containing particles of solid entrained therein, enters through a central feedwell, clarified liquor overflows into a launder around the periphery, and thickened sludge collects in the conical base and is raked by the slowly revolving mechanism to a central discharge point. In other variations of this device, the solid-liquid stream does not enter the separation device through a central feedwell. In order to increase the efficiency of such separation devices, the feedwell is generally designed to serve a greater purpose than to simply channel the solid-liquid stream to the device. The feedwell is typically designed to (i) act as a baffle to absorb the energy of the solid-liquid stream (herein referred to as ‘energy dissipation’) and thereby assist with gravity settling of the solid particles, (ii) to assist with flocculation of the solid particles in the solid-liquid stream and (iii) to distribute the solid-liquid stream exiting the feedwell uniformly across the settling area of the separation device proper. The nature of the flow in the feedwell is of critical importance to the performance of industrial separation devices as it is generally here that most of the flocculation occurs. The performance of the feedwell (for instance as measured by the throughput of the solid-liquid stream though the separation device, the clarity of the overflow, or the density of the underflow) directly affects the performance of the separation device proper.

Separation devices are required to cope with a range of solid-liquid stream flow rates. At high flow rates, turbulent flows are present and it is preferable that a significant amount of energy is dissipated from the solid-liquid stream before flocculation can be initiated. Unfortunately, currently available feedwell designs do not separate the energy dissipation and flocculation functions. Consequently, flocculation is typically hindered by the turbulent flow regime present. This creates a tendency for the solid particle agglomerates to less readily form, and more readily disaggregate, under these turbulent flow conditions. The end result is that the solid-liquid stream exits the feedwell, and enters the separation device proper, before the agglomerates have grown to a sufficient size. This ineffective flocculation and hence smaller agglomerates size hinders the settling of the agglomerates and increases the settling time. Consequently, the smaller agglomerates do not effectively separate from the supernatant, resulting in solid material being carried in the overflow out of the separation device, thereby reducing the efficiency and effectiveness of the device. In the extreme case, the solid-liquid stream leaving the feedwell is in a turbulent state and a significant proportion of the agglomerates within that exiting stream do not settle but instead short circuit the flocculation step and progress directly to the overflow.

If, on the other hand, the turbulent flow regime is avoided (for instance by the lowering of flow rates), the solid-liquid stream will not spend sufficient time within the feedwell, nor be subjected to sufficient mixing and solids dispersion to result in a desirable level of flocculation. The end result in this case is again that the exiting stream from the feedwell enters the separation device proper (ie the thickener, sedimentation device, clarifier etc that the feedwell forms a part of) before the solid particles have agglomerated to a sufficient size. An insufficient agglomerated particle size, and/or a turbulent solid-liquid stream, entering the separation device proper will result in: (a) reduced throughput of the separation device, (b) decreased clarity of the overflow, and therefore poor solid-liquid separation, and (c) decreased density of the underflow, and therefore loss of water recycling capacity and increased subsequent separated solids storage requirements.

The performance of currently available feedwells is dependent on many factors including the particle size and density of the suspended solids in the solid-liquid stream, the concentration of the suspended solids in the solid-liquid stream, and the flow rate of the solid-liquid stream through the feedwell. Since these parameters are unlikely to be steady in the industrial setting of the feedwell's use, there is a need for a feedwell that performs well under a range of operating conditions. Other benefits to an improved feedwell design include increased solid-liquid stream throughputs, greater operational stability of the separation device, and reduced use of coagulants or flocculants.

### SUMMARY OF THE INVENTION

According to a first aspect of the invention, there is provided an apparatus for the flocculation of solid particles in a solid-liquid stream including
an enclosure,
an upwardly converging flow diverter defining a first zone and a second zone within the enclosure, and
a solid-liquid stream inlet into the first zone of the enclosure at or towards the bottom of the first zone in proximity to the lower region of the flow diverter, the upwardly converging flow diverter having an upper opening for fluid communication between the first zone and the second zone.

It is preferable that the above apparatus is a feedwell for a separation device for separating solid particles from a liquid in a solid-liquid stream. The separation device may be one of a large number of known separation devices including a thickener, a clarifier, a washer, a settling tank, an agglomerator, a gravity sedimentation device, a centrifugal sedimentation device, a filtration device, a flocculation device, or a magnetic separation device. These devices are herein referred to generically as separation devices or solid separation devices.

The separation device includes a settling tank provided with a shaft for driving a solid disperser or rake. In the feedwell of the invention, when installed, the shaft passes centrally through the second zone and through the opening in the upwardly converging flow diverter.

In this aspect of the invention, an upwardly converging flow diverter is positioned in proximity to the inlet. The inlet directs a solid-liquid stream at or towards the bottom of the first zone in proximity to the lower region of the flow diverter. The solid-liquid stream is then directed by the outer surface of the flow diverter to flow in a direction tangential to the inner surface of the enclosure. In the preferred flow pattern, the solid-liquid stream thus spirals upwardly in the first zone directed by the contours of the flow diverter, dissipating energy as it progresses through the first zone.

The flow diverter is provided with an opening, which is preferably positioned centrally in the enclosure, for the fluid communication of the solid-liquid stream from the first zone to the second zone. Due to the design of the flow diverter, the solids will continue to circulate in the first zone at or above the top of the flow diverter until sufficient energy has been dissipated for solids and liquid to flow through the opening between the first and second zones.

Due to the downward movement of solids in the second zone and an increase in the mean particle size, bulk liquid is drawn upwardly from the bulk of the liquid in the separation device proper through a central region in the second zone of the flow diverter into the first zone above the top of the flow diverter establishing a mixing and diluting region for the solid-liquid stream and the bulk liquid. That is, the solid-liquid stream is mixed with and diluted by the bulk liquid in a mixing region that forms near or above the opening in the top of the flow diverter. The solid-liquid stream that has flowed from the lower region of the first zone, passed through the mixing region through the opening in the top of the flow diverter and into the second zone. The second zone is on the interior side of the flow diverter. The solid-liquid stream flows in the second zone counter-current to the bulk liquid rising centrally from the bulk of the separation device proper. Further, the solid-liquid stream substantially flows around the interior internal surface of the flow diverter, or the outermost non-central regions of the second zone. The interior internal surface of the flow diverter may be provided with one or more inlets preferably in the form of a sparge for a flocculating agent or other suitable agent. One flocculant inlet is preferably at the entry to the second zone in an upper region of the flow diverter. In this way, the solid-liquid stream flows from the mixing region in the first zone above the flow diverter, and through the opening in the flow diverter where flocculant is mixed with the solid-liquid stream entering the second zone. That is, in the second zone, flocculation of the solid particles may be initiated by mixing the solid particles with flocculant or other chemicals causing the mean diameter of the solid particles to further increase before exiting the enclosure.

In a preferred form of the invention, the base of the flow diverter is attached to the inner surface of the enclosure. The attachment is preferably below the level of the lower edge of the solid-liquid stream inlet, and may not be above the level of the upper edge of the solid-liquid stream inlet. As discussed elsewhere, the base of the flow diverter is attached so that the solid-liquid stream contacts with a lower region of the flow diverter soon after it enters the enclosure to allow the solid-liquid stream to spiral upwardly in the first zone for a substantial proportion of time and dissipate a significant amount of energy as it progresses through the first zone. One or more slots may be provided at the base of the diverter to allow removal of solid that has settled in the first zone or simply to allow solid to settle out of the first zone into the second zone or exit the enclosure. A slot may extend at least partially around the base of the diverter from a position behind the outlet of the solid-liquid stream inlet. It is preferable that a slot does not extend to a position in proximity to the front of the inlet.

The upwardly converging walls of the flow diverter which also converge inwardly may have a frusto-conical outer surface with the opening being defined at the top of the frustrum by the walls of the flow diverter. The inner surface of the flow diverter which defines the second zone may follow the shape of the outer surface thus giving the flow diverter a hollowed frusto-conicular appearance Alternatively the upward convergence of the flow diverter is stepped inwardly defining a number of concentric steps with conjoining walls.

The present invention is particularly applicable to retrofitting to existing solid separating devices which operate inefficiently or have to cater for increasing solids loads. Due to the improved efficiency demonstrated by the use of the invention, existing separation devices can be made to handle a higher throughput and/or solids load without necessarily increasing the settling volume required.

In a second aspect of the invention, there is provided a flow diverter for the entry enclosure of a separation device including:
an upwardly converging wall for positioning in an enclosure in proximity to a solid-liquid stream inlet of the enclosure, the flow diverter defining a first zone and a second zone in the enclosure and an opening for fluid communication between the first and second zones, the lower region of the flow diverter being positionable at or in proximity to the inlet to the enclosure.

According to a third aspect of the invention there is provided a method of improving the efficiency of an existing separation device having a feedwell including the steps of
determining the particle size distribution, flow rate ranges and solids concentration of a solid-liquid inlet stream,
determining the size, configuration and position of a flow diverter as described above suitable to handle the solid-liquid stream within the feedwell.

An additional benefit of the invention is that not only do the solid particles agglomerate and settle much more effectively but the solids settle much more uniformly across the separation device proper.

According to a fourth aspect of the invention there is provided a separation device including
a settling tank,
at least one feedwell positioned in the tank for receiving a solid-liquid stream, the feedwell having an enclosure,
an upwardly converging flow diverter defining a first zone and a second zone within the enclosure,
a solid-liquid stream inlet into the first zone of the enclosure in proximity to the lower region of the flow diverter, the upwardly converging flow diverter having an upper opening for fluid communication between the first zone and the second zone, the first zone having a mixing region above the upper opening for mixing and diluting of the solid-liquid stream with liquid from the settling tank,
the solid and liquid from the mixing region exiting the feedwell and settling in the settling tank.

In a preferred form of the above aspect, a flow path for bulk liquid in the settling tank is established centrally through the second zone into the first zone. This central flow path is preferably around a central shaft provided in the separation device through the flow diverter. The solid and liquid from the mixing region flows counter-current to the flow path of bulk liquid from the settling tank. The counter current flow of the solid and liquid from the mixing region preferably flows around the internal interior surface of the flow diverter.

Further features and advantages of the present invention will become apparent from the following description of the figures and preferred embodiment.

### BRIEF DESCRIPTION OF THE DRAWINGS

FIG. 1 is a schematic representation of the feedwell integration within a cylindrical continuous thickener with mechanical sludge-raking arms sedimentation device;

FIG. 2 is a diagram illustrating results of computational fluid dynamic modelling of particle flocculation in a conventional open feedwell with a shelf;

FIG. 3 is a schematic representation of the feedwell in accordance with the present invention, including a conical flow diverter and a solids removal slot;

FIG. 3(a) is a plan view of the embodiment in FIG. 3;

FIG. 4 is a schematic representation of the feedwell in accordance with the present invention, including a conical flow diverter including steps;

FIG. 4(a) is a plan view of the embodiment in FIG. 4;

FIG. 5 is a diagram illustrating results of computational fluid dynamic modelling of the feedwell in accordance with the present invention, including a conical flow diverter and indicating the solid-liquid stream flow streamlines;

FIG. 6 is a diagram illustrating results of computational fluid dynamic modelling of the feedwell in accordance with the present invention, including a conical flow diverter and indicating the solid-liquid stream velocity vectors;

FIG. 7 is a diagram illustrating results of computational fluid dynamic modelling of the feedwell in accordance with the present invention, including a conical flow diverter and indicating the effects of the feedwell on particle size;

FIG. 8 is a diagram illustrating results of computational fluid dynamic modelling of the feedwell in accordance with the present invention, including a conical flow diverter including steps, and indicating the flocculation of solid particles in the solid-liquid stream as the solid-liquid stream flows through the feedwell;

FIG. 9 is a graphical representation of the results of computational fluid dynamic modelling indicating the percentage of fines under 50 pm mean diameter exiting the feedwell as a function of flow rate for a conventional open feedwell, an open feedwell with a shelf, and a feedwell in accordance with the present invention (labelled ‘novel’);

FIG. 10 is a graphical representation of the results of computational fluid dynamic modelling indicating the momentum dissipation ratio (defined as the ratio of momentum of fluid leaving the feedwell divided by the total momentum entering the unit) as a function of flow rate for particles entering the feedwell in a conventional open feedwell, an open feedwell with a shelf, and a feedwell in accordance with the present invention (labelled ‘novel’); and

FIG. 11 is a graphical representation of the results of computational fluid dynamic modelling indicating the average agglomerate size exiting the feedwell as a function of flow rate for a conventional open feedwell, an open feedwell with a shelf, and a feedwell in accordance with the present invention (labelled ‘novel’).

### DETAILED DESCRIPTION OF THE EMBODIMENTS

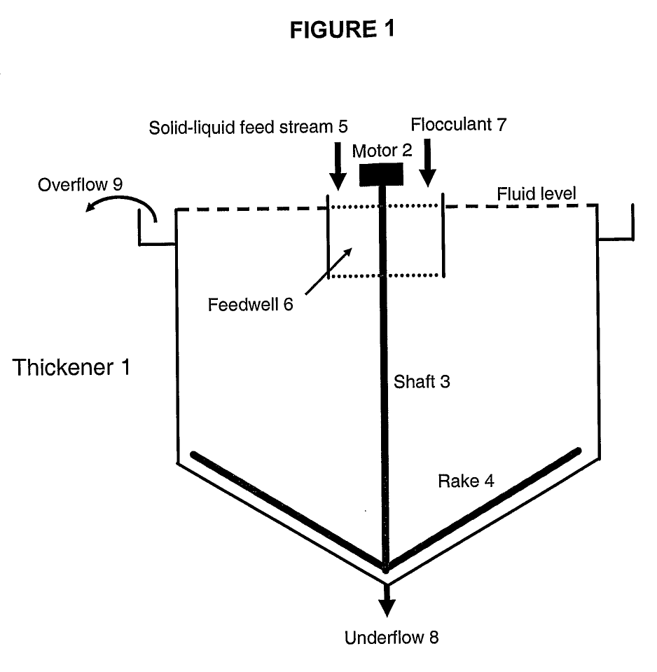

Referring to FIG. 1, a conventional thickener 1 is shown comprising a motor 2 driving a shaft 3 and rake 4. A solid-liquid stream 5 is fed through inlets to feedwell 6. The inlets of the prior art feedwells are located towards the top of the feedwell. In feedwell 6, flocculant 7 is added to the solid-liquid stream in order to initiate flocculation of the particles which in turn settle out of the feedwell into the bulk of the thickener. The solids settle into the lower region of the thickener and are taken out through an outlet 8. The solids are moved towards the outlet 8 by rake 4 and the slope on the floor of the thickener. The supernatant liquor is removed through a perimeter outlet 9.

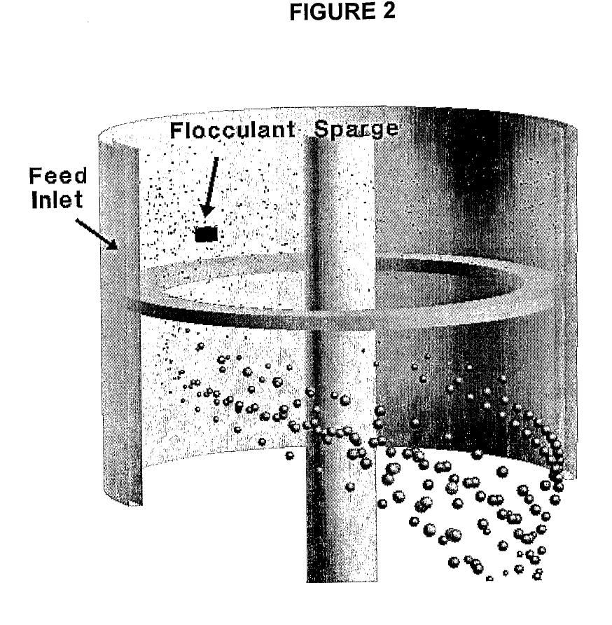

FIG. 2 is a schematic representation illustrating the flocculation of a solid-liquid stream in a conventional shelf type feedwell. The shelf is typically in the top third of the feedwell and the inlets of this prior art feedwell may be anywhere above the shelf, but are typically located towards the top of the feedwell. It can be seen that the solids are not retained within the feedwell for any substantial period of time and are poorly mixed with flocculant. The result is poor flocculation.

While the invention will be described and is particularly applicable to single feedwells centrally located in a settling tank, the invention is not limited to these situations. It would be appreciated by those skilled in the art that in some settling tanks multiple feedwells may be provided or the feedwells may not be centrally located. The invention has application in these situations.

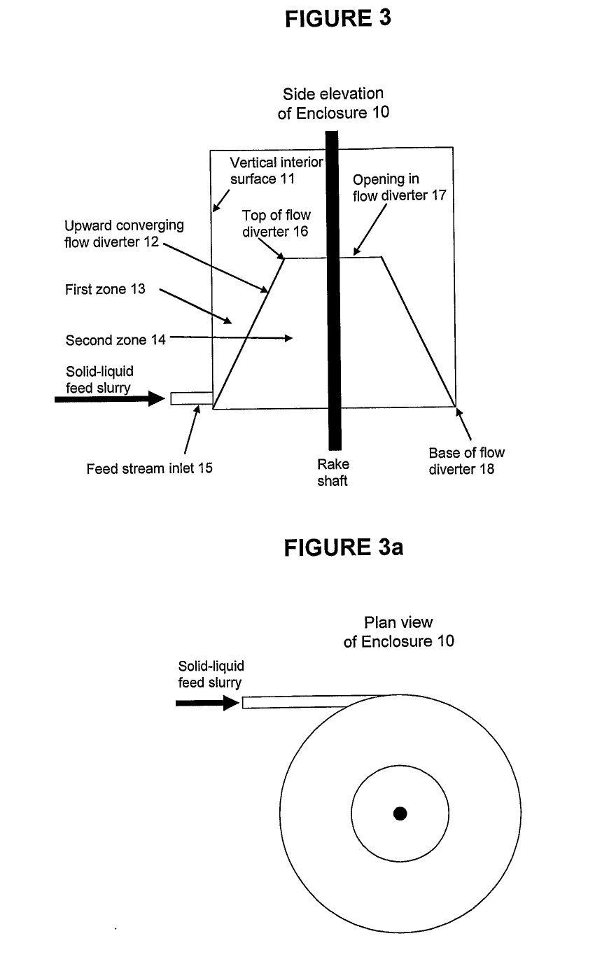

Referring to FIG. 3, an enclosure 10 is shown as a feedwell for a continuous thickener having a flow diverter 12 in accordance with the invention. The substantially vertical interior surface 11 of the enclosure 10 is typically substantially cylindrical. The enclosure may have a solid covering at the top, but must be substantially open at its base to allow outward flow of the solid-liquid stream. The material used to form the enclosure may be any material well-known in the art to suit this application (such as sheet metal); however it is preferable that the surface be smooth to reduce the effects of fouling. The diameter of the enclosure can be any as currently used in the art, or any diameter suitable for the given operating parameters. Typically, enclosures for use in a feedwell for a separation device have a diameter of about 2 m to about 15 m.

In the embodiment of the invention shown in FIG. 3, an upwardly converging flow diverter 12 is positioned within the enclosure 10. The flow diverter 12 separates the enclosure into a first zone 13 and a second zone 14. A solid-liquid stream of solids entrained in a liquid is introduced into the first zone of enclosure 10 through a solid-liquid stream inlet 15. Typically, the solid-liquid stream inlet is the end region of an inlet conduit that carries solid-liquid stream from an upstream location.

The cross-section of the solid-liquid stream inlet is typically circular, however may be any other geometry, for example it could be triangular or square. The size of the solid-liquid stream inlet is typically sized to provide a flow velocity of about 0.5 m/s-2.5 m/s. For instance, for an enclosure for a feedwell that has a skirt of about 1 m to about 10 m, the diameter of the solid-liquid stream inlet may be from about 0.2 m to about 2 m. However, the design of these features is specific to the intended operation.

The solid-liquid stream inlet is to be positioned within the enclosure, and in proximity to the base of the flow diverter. Typically the solid-liquid stream inlet should not be positioned more than a distance of about twice the diameter of the solid-liquid stream inlet above the join between the base of the flow diverter and the enclosure (discussed more below). That is, the inlet may be positioned a distance of not more than twice the inlet diameter above the base of the flow diverter. Preferably, the solid-liquid stream inlet should not be positioned more than a distance of about the diameter of the solid-liquid stream inlet above the join between the base of the flow diverter and the enclosure. That is, the inlet may be positioned a distance of not more than the inlet diameter above the base of the flow diverter.

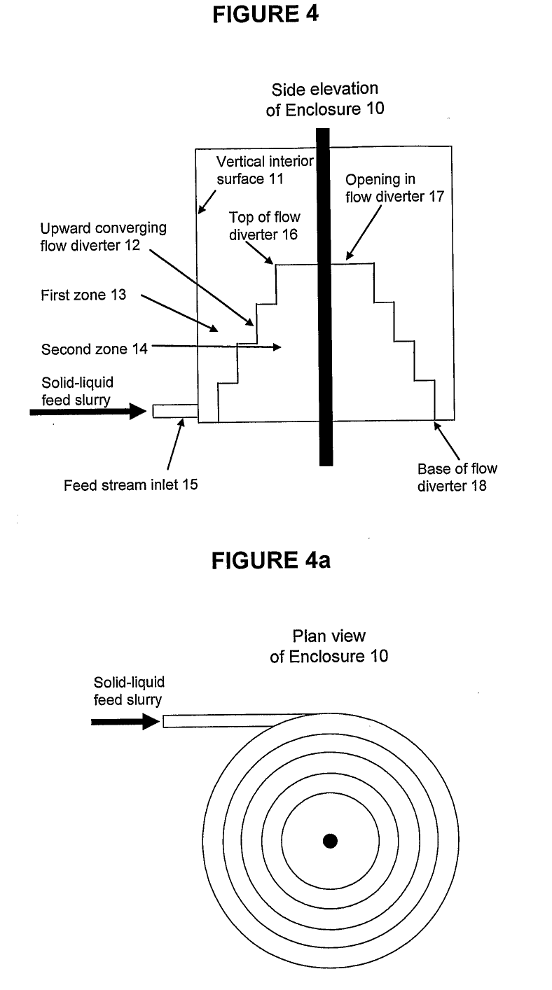

The inlet may be positioned such that the solid-liquid stream is directed to flow tangentially with respect to the cylindrical walls of the enclosure. For instance, the inlet conduit substantially exterior the enclosure and running through the cylindrical walls of the enclosure may not be orthogonal to the cylindrical walls of the enclosure. That is, the inlet conduit may enter the enclosure at an angle to direct the solid-liquid stream to flow tangentially with respect to the cylindrical walls of the enclosure. This embodiment is shown in FIG. 3a and FIG. 4a. The inlet may further include a nozzle for directing the flow of the solid-liquid stream to be tangential to the cylindrical walls of the enclosure. Such nozzles are well-known in the art. While it is envisaged that only one solid-liquid stream inlet will be required, more than one solid-liquid stream inlet could be used without affecting the essential aspects of the invention. It would also be possible to use one or more inlets to reduce or increase the solids concentration in the solid-liquid stream if this was desirable. This could be achieved by feeding supernatant liquor, concentrated sludge, some mixture of these or some other solid-liquid stream through the additional solid-liquid stream inlets.

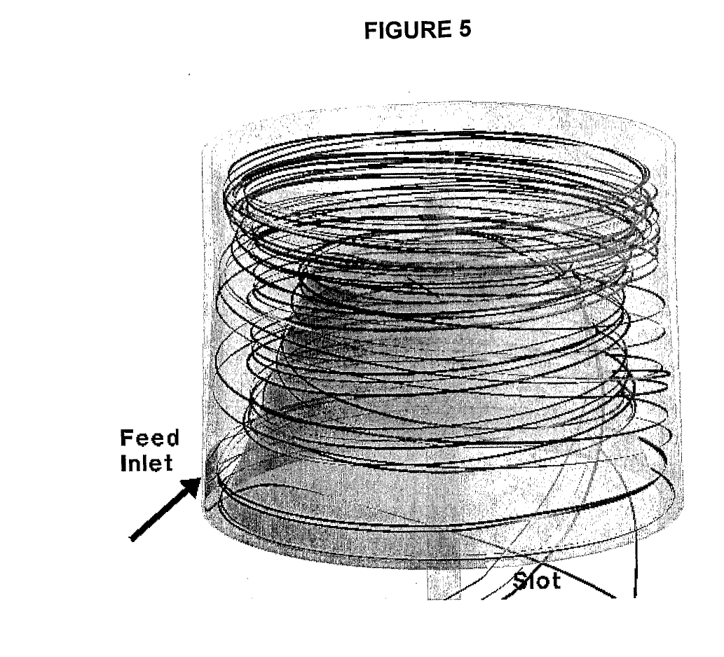

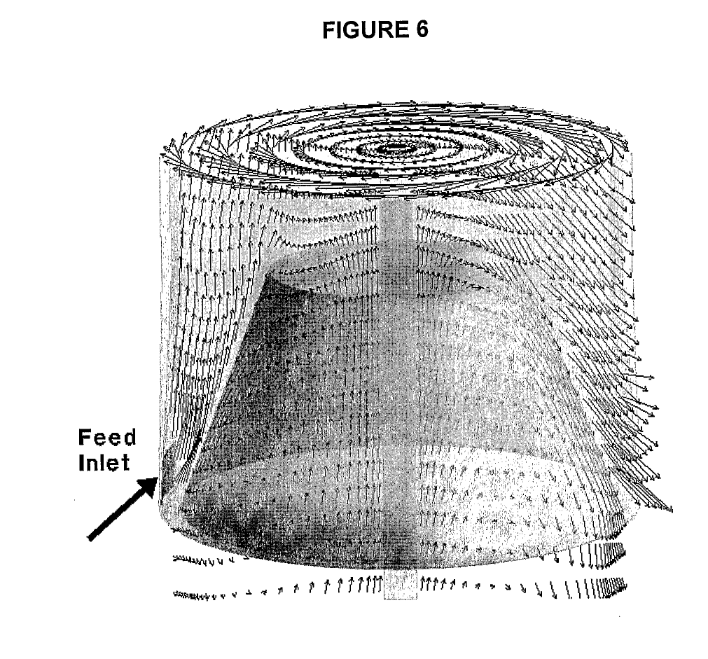

The solid-liquid stream is preferably directed into the lower region of the first zone to be in proximity to the flow diverter 12 so that a surface of the lower region of the flow diverter 12 in proximity to its base contacts the solid-liquid stream soon after the solid-liquid stream enters the enclosure via the solid-liquid stream inlet 15. A solid-liquid stream inlet positioned towards the top of the enclosure, directing solid-liquid stream into the upper region of the first zone to first contact a surface of the upper region of the flow diverter 12 is not considered to be an inlet in proximity to the flow diverter. The flow diverter 12 converges upwardly, so that the top 16 of the flow diverter 12 is smaller in cross-section than the base 18 of the flow diverter. Hence the flow diverter 12 could also be described as converging inwardly in the first zone 13. The base 18 of the flow diverter may be of a smaller diameter than the enclosure. In this case, a join is preferably formed between the flow diverter and the interior surface of the enclosure (discussed further below). As the solid-liquid stream circulates in the first zone 13 directed by the flow diverter 12 towards the top 16 of the diverter 12, the solid-liquid stream dissipates kinetic energy through frictional forces while also gaining potential energy in the form of hydrostatic head. This is best shown in FIGS. 5 and 6. The flow diverter 12 is designed so that the solid-liquid stream can dissipate sufficient energy prior to exiting the first zone. Then, the solid-liquid stream then passes through an opening 17 in the top 16 of the flow diverter provided for communication between first zone and the second zone. Contact of the solid-liquid stream with the flow diverter soon after it enters the enclosure, and with a lower region of the flow diverter, allows the solid-liquid stream to spiral upwardly in the first zone for a substantial proportion of time, being directed by the contours of the flow diverter, and dissipating energy as it progresses through the first zone.

Further, solid-liquid streams are often aerated, with air bubble engagement to solid particles in the solid-liquid stream leading to decreased settling capacity, and/or short-circuiting directly to the overflow of the separation device, of those solid particles. Positioning the inlet towards the base of the enclosure such that the solid-liquid stream is directed into a lower region of the first zone and contacted with a lower region of the flow diverter also substantially prevents short-circuiting of the solid-liquid stream directly to the overflow of the separation device and thus prevents insufficient agglomeration resulting from such flow of the solid-liquid stream substantially directly from the inlet to the second zone. The first zone, and the forced upward flow of the solid-liquid stream through the first zone to the free surface of the liquid within the enclosure, also advantageously allows for a period of disengagement and de-aeration of any air bubbles within the solid-liquid stream. Further, the solid-liquid stream typically includes components and/or contaminants that result in a froth or scum-like substance that accumulates on any free liquid surface. In a solid separation device of the prior art, this froth ‘escapes’ the feedwell and forms across the free liquid surface of the entire separation device. Without wishing to be bound by theory, the inventors believe that the feedwell of the present invention will minimise froth ‘escaping’ the feedwell due to the forced flow of the solid-liquid stream and it's froth through the first zone to the free surface of the liquid within the enclosure. It is thought the froth will collect on this surface rather than passing through the feedwell and into the separation device proper.

The flow diverter 12 is designed such that the solid-liquid stream is able to pass through the first zone 13 which is an interior space in the enclosure 10 bound by the surfaces of the flow diverter 12 and the enclosure 10. The solid particles are then able to flow into the opening formed in the top of the flow diverter 12 enabling communication with the second zone 14. The second zone 14 is defined by the interior surface of the flow diverter 12.

The flow diverter 12 is attached to the interior surface of the enclosure such that a join is formed between the flow diverter and the interior surface of the enclosure. The join between the flow diverter and the enclosure may extend around a substantial portion of the interior circumference of the enclosure and preferably completely around the interior of the enclosure so that the solid-liquid stream is unable to short-circuit the enclosure by flowing down and out of the enclosure bypassing the flow diverter instead of being forced to flow upwards within the enclosure.

Alternatively, the flow diverter 12 may be attached to the outer edge of a shelf (not shown) that is attached to the interior surface of the enclosure 10, such that the joins between the flow diverter 12 and the shelf, and the shelf and the interior surface of the enclosure, extend a substantial portion of the interior circumference of the enclosure and preferably completely around the interior circumference of the enclosure. This shelf may have an annular thickness of up to about 10% of the diameter of the enclosure.

The flow diverter 12 may be generally conical in shape or at least the surface is contoured upwardly and inwardly at an incline to resemble a frustrum of a cone. Hence, as shown in FIG. 5, the exterior surface of the flow diverter may be a series of steps of decreasing diameter joined such that the flow diverter is substantially conical. The steps may have a depth of about 5% to about 25%, and a height of about 7% to about 25%, of the diameter of the enclosure. There may be from about 2 to about 7 steps on an individual flow diverter 12. For a diverter including steps, the interior surface of the flow diverter may follow the steps of the exterior surface, or may have a smooth surface without steps. Alternatively the step could be a continuous spiral or series of spirals starting at the base and terminating at the top of the frustrum. The material used to form the flow diverter 12 may be any material well-known in the art to suit this application (such as sheet metal); however it is preferable that the surface be smooth to reduce the effects of fouling.

The dimensional parameters of any flow diverter depend on the given operating parameters, particularly the solid-liquid stream flow rate. The flow diverter extends about 50% to about 90% of the height of the enclosure. Preferably, the flow diverter extends about 60% to about 80% of the height of the enclosure. Most preferably, the flow diverter extends about 65% to about 68% of the height of the enclosure. The horizontal cross-sectional area at the top of the flow diverter is referred to as the throat.

The diameter of the throat of the flow diverter is about 30% to about 70% of the interior diameter of the enclosure. Preferably, the diameter of the throat of the flow diverter is about 40% to about 60% of the interior diameter of the enclosure. Most preferably, the diameter of the throat of the flow diverter is about 48% to about 52% of the interior diameter of the enclosure. The upwardly convergent nature of the surface of the flow diverter results in an angle of incline defined as the angle between the interior surface of the flow diverter and the horizontal made at the level at which the flow diverter is attached to the interior surface of the enclosure. The angle of incline of the flow diverter is about 20° to about 80°. Preferably, the angle of incline of the flow diverter is about 30° to about 70°. Most preferably, the angle of incline of the flow diverter is about 55° to about 65°.

One or more flocculants are preferably added to cause particle-particle bonding and hence an increase in the mean particle size distribution. Flocculation agents are well-known in the art and include natural polymers, such as nirmali nut, burn-corn starch, tuna cactus, guar gum, gelatin, and synthetic flocculants such as polyacrylamides, polyacrylates, acrylamide/acrylate copolymers, hydroxamated polyacrylamides, as well as other flocculant aids such as sodium silicate, alum, lime, and alumina. The flocculant is preferably supplied as a steady stream of a solution/suspension of the flocculant. In this case the flocculant feed solution/suspension concentration is about 0.01 wt % to about 2 wt %. The required flocculant feed solution/suspension flow rate for good flocculation will depend upon the particle size and concentration of the solids in the solid-liquid stream, and the solid-liquid stream solids flow rate to the enclosure. The flocculant may be supplied in solid form. In some cases the flocculating agent may be supplied intermittently in place of a steady stream. The person skilled in the art would be able to determine an appropriate flocculant dosing regime for a particular separation device.

A flocculant sparge for the delivery of flocculant to the solid-liquid stream may therefore be included within the apparatus. However, it would also be possible to operate the device without addition of flocculant. The flocculant sparge is to be positioned such that flocculant is introduced to the solid-liquid stream while the solid-liquid stream is in a substantially non-turbulent flow regime. Flocculant added to a turbulent solid-liquid stream may not result in effective flocculation since the turbulence could lead to some disaggregation of any particle agglomerates that formed. Preferably the flocculant sparge is positioned within the space bound by the surfaces of the flow diverter; the second zone 14. For instance, the flocculant sparge may be positioned within the interior surface of the flow diverter, or it may be positioned so that the flocculant is delivered in proximity to the interior surface of the flow diverter, as opposed to being delivered to a central region of second zone 14. As the mean particle size distribution increases, the settling velocity of the particles increases. The increased settling velocity of the particles sinking down around the interior internal surface of the flow diverter displaces the liquid and creates an upward flow of the liquid. The upward flow of the liquid originates in the second zone 14 and continues into the first zone 13 forming a mixing region in the first zone above the opening in the flow diverter. According to modelling predictions, this upwards flow, which mostly varies from 0.8 up to 1.8 times the volume of the solid-liquid stream flow rate, occurs in the central region of second zone 14 around the rake shaft allowing for downwards flow of the solid-liquid stream at the outer region of second zone 14. This is seen in the computational modelling results displayed in FIG. 6. Advantageously, this upward flow of liquid into a mixing region in the first zone 13 creates an automatic (or natural) dilution of the solid particles entrained in the liquid of the first zone 13.

In some instances, it may be desirable to further dilute the solid-liquid stream within the enclosure. Typically, this may be done by having dilution liquid enter the top of the feedwell above the free surface of the liquid within the feedwell. This dilution liquid may be provided using any known means.

A flocculant sparge positioned so that the flocculant is delivered in proximity to the rotating rake shaft would not be as effective as those described above, since flocculant would be entrained upwards with the upwards flow along the rake shaft and into the turbulent mixing region of the first zone where flocculation is inefficient.

There may be a single flocculant sparge employed, or there may be a multiple of flocculant sparges employed and positioned as described above. A ring sparge or any other flocculant sparge known in the art could be employed.

A solids removal slot, or a number of slots, may be included in the apparatus of the invention, to allow the removal of solid particles that have settled and accumulated in the lower portion of the first zone. The solids removal slot may be positioned within either (i) the surface of the flow diverter in proximity to the base of the flow diverter, (ii) the attachment itself of the flow diverter and the enclosure, or (iii) the interior shelf that joins the flow diverter and the interior surface of the enclosure. The size of the solids removal slot may be about 4 cm to about 15 cm. The solids removal slot should be positioned behind the solid-liquid stream inlet. For example, if the solid-liquid stream is directed tangentially clockwise, the solids removal slot may be located in proximity to the solid-liquid stream inlet in an anti-clockwise direction. The solids removal slot may be positioned at up to about 50% of the interior circumference of the enclosure behind the solid-liquid stream inlet. Preferably, the solids removal slot is positioned at about 25% of the interior circumference of the enclosure behind the solid-liquid stream inlet. More preferably, the solids removal slot is positioned at about 10% of the interior circumference of the enclosure behind the solid-liquid stream inlet.

The height of the enclosure (known in the art as the ‘skirt’), and measured from the level at which the flow diverter is attached to the interior surface of the enclosure to the level of the fluid within the enclosure when in operation, may be any currently used in the art, or any suitable height for the given operating parameters. Typically, enclosures for use in a feedwell for a separation device have a height of about 1 m to about 10 m. The interior diameter of the enclosure may be any currently used in the art, or any suitable height for the given operating parameters. Typically, enclosures for use in a feedwell for a separation device have a diameter of about 2 m to about 15 m.

The solid-liquid stream can have a solids content of about 0.1 wt % to about 40 wt %. The liquid within the solid-liquid stream may have a specific gravity within the range 0.9 to 1.5. For instance, the liquid within the solid-liquid stream may be water. The solid particles within the solid-liquid stream may have a specific gravity in the range of about 0.8 to about 12. For instance, the solid particles within the solid-liquid stream may be magnesia, alumina red mud, copper middlings and concentrates, gold tailings, lead concentrates, mineral sands, sewerage sludge, organic and inorganic particulates such as those present in unpurified drinking water, china clay (kaolin), coal tailings, phosphate slimes, pulp-mill wastes. A solid-liquid stream flow rate through the feedwell of about 100 m³/h to about 20000 m³/h is typical.

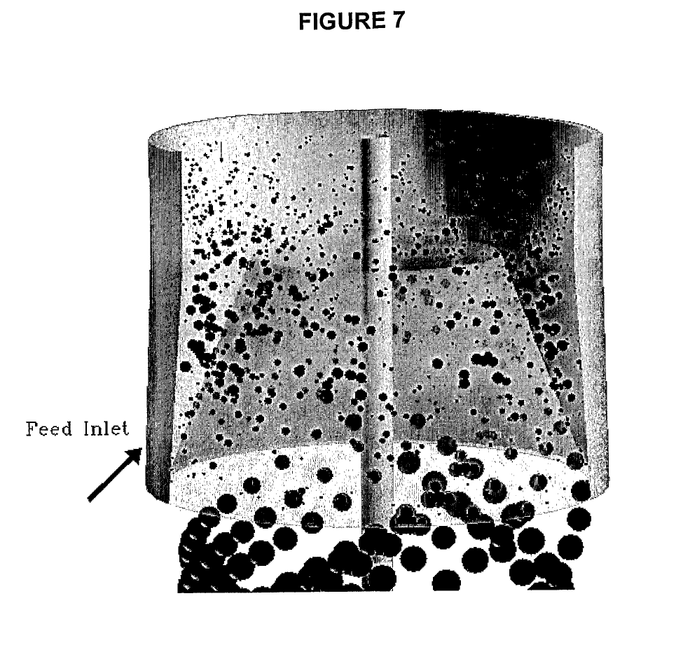

FIG. 7 shows the results of computational modelling illustrating the effectiveness of the invention as an agglomerator. In the illustration, a solid-liquid stream containing solids having a particle size of 16 μm and an entry flow rate of 1000 m³/h enters through a 0.5 m diameter inlet into a 4 m diameter enclosure. The angle of inclination of the flow diverter is 60 degrees and the solid-liquid stream inlet is 0.2 m above the base of the flow diverter and 2.3 m from the top of the enclosure. The solid-liquid stream rises up in the energy dissipation region i.e. the first zone and then progress through an opening of 2 m diameter at the top of the flow diverter. The solid-liquid stream then enters the mixing region combining with flocculant to agglomerate and exit the enclosure.

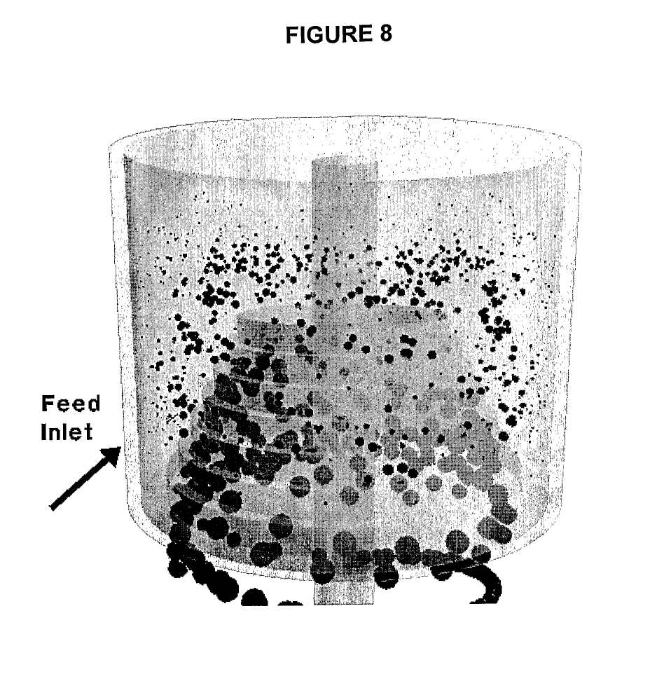

FIG. 8 similarly illustrates the effects with a stepped flow diverter of a second embodiment of the invention.

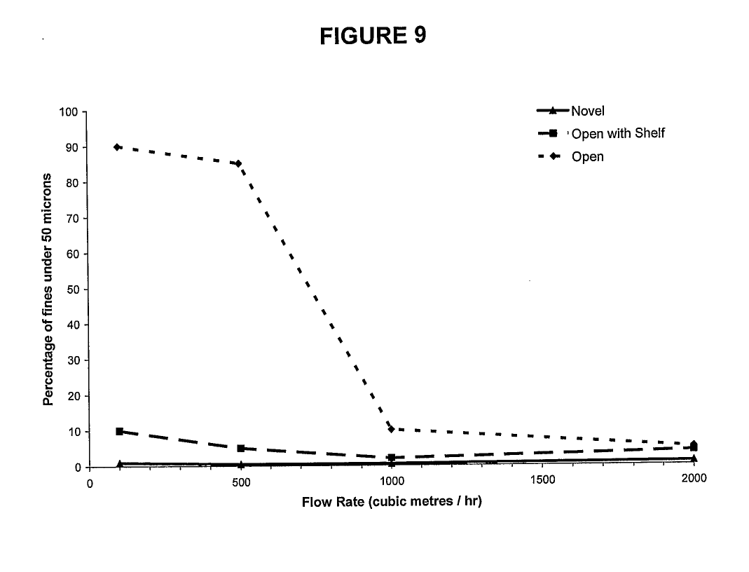

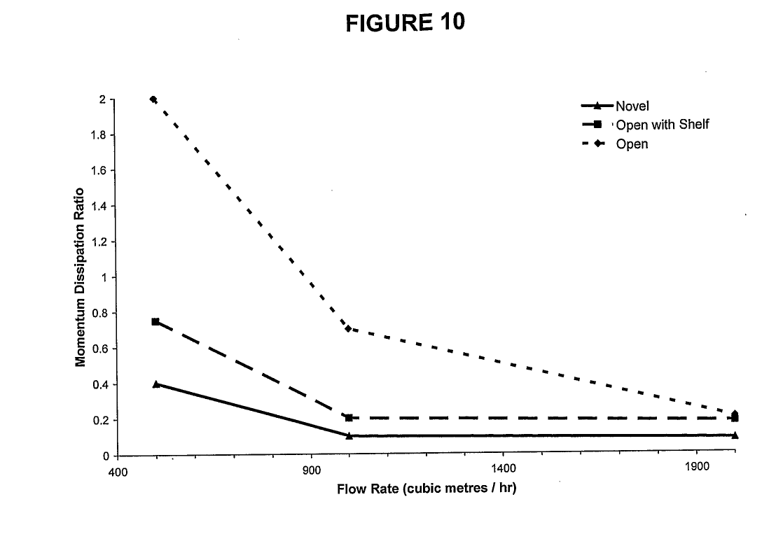

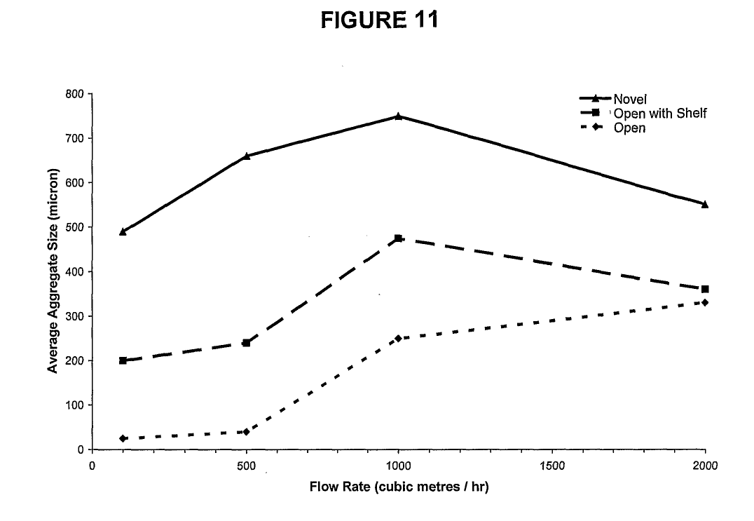

FIGS. 9, 10 and 11 are the results of comparative modelling of the invention against a conventional open feedwell and a feedwell with a shelf over a range of flow rates. The embodiment of the invention used comprises a conical flow diverter with 7 steps. The steps have a width of 0.12 m and height of 0.24 m, and are spaced regularly up the flow diverter. The angle of inclination of the flow diverter is 60 degrees. The solid-liquid stream consists of particles of mean diameter of 16 μm. In each model, the feedwell consists of a 4 m enclosure with an inlet of 0.5 m diameter. In the case of the shelf-type feedwell, the shelf has an annular width of 0.4 m. The inlet for the conventional feedwell is 0.75 m from the top of the enclosure whereas the inlet for the shelf-type feedwell is 0.1 m above the shelf and the shelf was positioned 1.35 m from the top of the enclosure. In the embodiment of the present invention the inlet is 0.24 m above the base of the flow diverter and 2.25 m from the top of the enclosure. It can be seen that the enclosure design of the present invention produces superior sized solid particles over a range of flow rates. As each of the models use the same quantities of flocculant, it can be seen from FIG. 9 that there is a much smaller amount of fine particles produced in the invention indicating a much more effective use of the flocculant. FIG. 11 shows that by introducing the solid-liquid stream to a lower region of the first zone and towards a lower region of the flow diverter, the design of the present invention clearly dissipates a much greater percentage of the energy upon entry into the enclosure. It is considered that this greater energy dissipation leads to the vastly improved flocculation and more effective use of flocculant displayed in the present invention, as shown in FIG. 11.

A further advantage of the present invention is the feasibility of retrofitting either (i) the flow diverter to an existing feedwell, or (ii) the feedwell (enclosure and feed diverter combined) to an existing separation device. The inventors believe that this would improve the operational efficiency of existing separation devices. For example, there are currently in operation separation devices where the depth of the settling area is insufficient (too shallow) for the desired level of flocculation given the solid-liquid stream introduction device currently employed. It is believed that the feedwell of the present invention would allow such shallow separation devices to be retrofitted and thus made more functional. Further, it is believed that the feedwell of the present invention would allow the design of shallower, yet still efficient, separation devices thereby saving on material, operational (for example energy), and device footprint-related costs.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. An apparatus for the flocculation of solid particles in a solid-liquid stream, including
an enclosure, including at least one solid-liquid stream inlet; and
an upwardly converging flow diverter defining a first zone and a second zone within the enclosure, the solid-liquid stream inlet being positioned in a lower region of the enclosure to provide solid-liquid stream into the first zone at or towards the bottom of the first zone and in proximity to the lower region of the flow diverter, the upwardly converging flow diverter having an upper opening for fluid communication between the first zone and the second zone.

2. The apparatus of claim 1, the inlet having an inlet diameter, and being positioned a distance of not more than the inlet diameter above a base of the flow diverter.

3. The apparatus of claim 1, the inlet being positioned such that the solid-liquid stream is directed by an outer surface of the flow diverter to flow in a direction substantially tangential to an inner surface of the enclosure.

4. The apparatus of claim 1, the inlet being such that as the solid-liquid stream enters the enclosure it flows in a direction substantially tangential to an inner surface of the enclosure.

5. The apparatus of claim 1, wherein a base of the flow diverter is attached to an inner surface of the enclosure below the level of a lower edge of the inlet.

6. The apparatus of claim 2, wherein the base of the flow diverter is attached to an inner surface of the enclosure at a distance of not more than an inlet diameter below the level of a lower edge of the inlet.

7. The apparatus of claim 1, further including at least one flocculant inlet positioned near the inner side of the flow diverter and the upper region of the second zone.

8. The apparatus of claim 1, further including at least one slot at or near the base of the diverter to allow removal of solid that has settled in the first zone.

9. The apparatus of claim 1, the flow diverter converging upwardly and inwardly.

10. A feedwell including the apparatus of claim 1, the feedwell being for a solid separation device.

11. The feedwell of claim 8, the separation device being selected from the group consisting of thickeners, clarifiers, washers, settling tanks, agglomerators, gravity sedimentation devices, centrifugal sedimentation devices, filtration devices, flocculation devices, and magnetic separation devices.

12. A flow diverter for an entry enclosure of a separation device including:
an upwardly converging wall for positioning in the enclosure below a solid-liquid stream inlet of the enclosure, the flow diverter defining a first zone and a second zone in the enclosure and an opening for fluid communication between the first and second zones, the lower region of the flow diverter being positioned when in use at or in proximity to the inlet to the enclosure.

13. The flow diverter of claim 12, the lower region of the flow diverter being positioned when in use in the entry enclosure a distance of not more than the diameter of the inlet below the level of a lower edge of the inlet.

14. A method of improving the efficiency of an existing separation device having a feedwell including the steps of
determining the particle size distribution, flow rate ranges and solids concentration of a solid-liquid inlet stream,
determining the size, configuration and position of a flow diverter according to claim 12 to handle the solid-liquid stream within the feedwell.

15. A separation device including
a settling tank;
at least one feedwell positioned in the tank for receiving a solid-liquid stream, the feedwell having an enclosure including at least one solid-liquid stream inlet; and
an upwardly converging flow diverter defining a first zone and a second zone within the enclosure, the solid-liquid stream inlet being positioned in a lower region of the enclosure to provide solid-liquid stream into the first zone and in proximity to the flow diverter, the upwardly converging flow diverter having an upper opening for fluid communication between the first zone and the second zone, the first zone having a mixing region above the upper opening for mixing and diluting of the solid-liquid stream with liquid from the settling tank;
the solid-liquid stream from the mixing region exiting the feedwell and settling in the settling tank.

16. The separation device of claim 15, wherein the liquid from the settling tank enters the mixing region by being drawn upwardly through a central region in the second zone.

17. The separation device of claim 16, wherein the liquid from the settling tank flows counter-currently to the solid-liquid stream in the second zone.

18. The separation device of claim 17, the separation device being selected from the group consisting of thickeners, clarifiers, washers, settling tanks, agglomerators, gravity sedimentation devices, centrifugal sedimentation devices, filtration devices, flocculation devices, and magnetic separation devices.
